(19) United States
(12) Patent Application Publication
(10) Pub. No.: US 2016/0135487 A1
(43) Pub. Date: May 19, 2016

(54) STABILISED FOOD PRODUCTS

(71) Applicant: Crisp Sensation Holding S.A., Geneva (CH)

(72) Inventors: Wilhelmus Johannes Gerardus Michiels, Nederweert (NL); Bianca Van der Kolk, Hertogenbosch (NL)

(21) Appl. No.: 14/548,169

(22) Filed: Nov. 19, 2014

(51) Int. Cl. A23L 1/09; A23L 1/01; A23L 1/00

(52) U.S. Cl. CPC A23L 1/095; A23L 1/005; A23L 1/0107; A23V 2002/00

(57) ABSTRACT

A stabiliser composition comprising, calculated by weight of dry matter:

| | | |
|---|---|---|
| cellulose gum | 5-25 | wt. % |
| modified starch | 10-50 | wt. % |
| maltodextrin | 10-55 | wt. % |
| polydextrose | 0-45 | wt. % |
| protein | 0-20 | wt. % |
| hydrocolloid | 1-10 | wt. % |
| other ingredients | 0-30 | wt. %. |

This invention relates to a composition for stabilising a food product to prevent moisture loss during heating, particularly from the core of a coated product or the filling of a product comprising an outer layer surrounding a fluid or semi-solid filling. The invention relates particularly to stabilisation of food products which are heated in a conventional oven or grill. The invention also relates to a method of stabilising a food product and products stabilised according to the method.

WO97/03572 discloses a method of stabilising a microwave cookable or reheatable food material by impregnation of the product with a stabiliser composition comprising cellulose gum, modified starch, polydextrose, xanthan gum, egg albumen and pea starch.

EP 2359697 and EP 2374361 disclose improved methods of manufacture of stabilised food products which may be fried, frozen and subsequently reheated in a microwave oven. The requirements for stabilisation of microwaveable food products are exacting because microwave radiation heats water contained in the interior of the product, causing a release of steam which can impair the integrity of the coating layers or cause leakage of a filling. In order to overcome these problems a stabiliser has been added to the core substrate or to the filling. This stabiliser comprises cellulose gum (Methocel A4M), modified starch (Thermflo), polydextrose, xanthan gum and egg albumen.

The stabiliser compositions described in the aforementioned patent publications were designed for use in microwaveable food products. Although they may be used in food products that are normally cooked or reheated in thermal ovens, these stabiliser compositions do not produce optimal results in this type of food products. Consequently, there is a need for a stabiliser composition that enables preparation of food products that can suitably be cooked or reheated in a conventional oven or grill, and preferably also in a microwave.

The inventors have developed a stabiliser composition that meets the aforementioned requirements.

According to a first aspect of the present invention a stabiliser composition comprises, calculated by weight of dry matter:

| | | |
|---|---|---|
| cellulose gum | 5-25 | wt. % |
| modified starch | 10-50 | wt. % |
| maltodextrin | 10-55 | wt. % |
| polydextrose | 0-45 | wt. % |
| protein | 0-20 | wt. % |
| hydrocolloid | 1-10 | wt. % |
| other ingredients | 0-30 | wt. % |

The composition includes a dextrose component which consists of maltodextrin with optional polydextrose.

All percentages mentioned herein, unless indicated otherwise, are to be construed as percentages by weight and the amounts of the ingredients are selected from any ranges of percentages quoted to total 100%.

The stabiliser composition preferably contains 2% to 55% maltodextrin by weight of dry matter, more preferably 20% to 40% maltodextrin by weight of dry matter and most preferably 25% to 28% maltodextrin by weight of dry matter.

The polydextrose content of the stabiliser composition preferably is 0% to 45% maltodextrin calculated by weight of dry matter, more preferably 6% to 30% by weight of dry matter and most preferably 12% to 15% by weight of dry matter.

The maltodextrin preferably has a dextrose equivalent (DE) value between 3 and 20, preferably in the range of 8 to 20. The DE value is a measure of the reducing power compared to a standard of 100 for dextrose.

The combined amount of maltodextrin and polydextrose in the stabiliser composition preferably constitutes 30% to 55 wt % of the stabiliser composition, more preferably 20% to 50 wt % by weight of dry matter of the stabiliser composition, most preferably 25% to 45 wt % of the stabiliser composition,

Mixtures of maltodextrin and polydextrose which find particular application have a ratio of maltodextrin:polydextrose in the range about 5:1 to about 1:5 by weight, preferably in the range of about 3:1 to about 1:2, most preferably about 1:1.

Microwaveable products may be fried in oil at 180 to 185° C. for 2.5 minutes to ensure that all moisture is driven from the coating. In order to reduce the size of ice crystals formed in the coating layer, the fried products may be frozen in a cryogenic freezer operating at −60° C. to −70° C. until the core temperature is −25° C. to −30° C.

In contrast, an ovenable product of the present invention may only need to be fried for 2 minutes at 180 to 185° C. to ensure a crisp and moisture free coating after cooking in a conventional oven. Less severe freezing is necessary, for example using a freezer operating at −40° C. to give a core temperature of −15° C. to −20° C. because absence of formation of ice crystals in the surface layer is less critical.

Use of maltodextrin is particularly beneficial in sauce compositions for filled products because it does not act as a thickening agent.

The amount of modified starch in the stabiliser composition is preferably from about 12% to about 40%, more preferably from about 14% to about 35%, most preferably from about 15% to about 30%.

The protein is preferably selected from the group consisting of: egg albumen, whey protein, soy protein and mixtures thereof. Use of egg albumen is preferred.

In alternative compositions no egg albumen or other egg products are present. Where present the protein may be contained in the stabiliser composition in an amount of about 1-20% by weight of dry matter.

Suitable hydrocolloids may be selected from the group consisting of: xanthan gum, carageenan gum, guar gum and mixtures thereof. Use of xanthan gum, guar gum or mixtures thereof is particularly preferred Use of xanthan gum or a mixture of hydrocolloids containing xanthan gum is especially preferred. An amount of about 3% to about 10% by weight of dry matter, particularly about 6% by weight of dry matter is preferred. Preferably gelatine is not used in compositions of this invention.

The cellulose gum and modified starch may be considered to act as a thermal gelation component. Without wishing to be bound by theory it is believed that the gelation component may serve to form a thermosetting gel during heating preventing loss of water from the substrate.

In a preferred embodiment the stabiliser composition comprises, calculated by weight of dry matter:

| | |
|---|---|
| cellulose gum | 5-25% |
| modified starch | 16-35% |
| maltodextrin | 16-.35% |
| polydextrose | 5-25% |
| hydrocolloid | 1-10% |
| egg albumen | 1-20% |
| other ingredients | 0-25%. |

Wherein the percentages of the ingredients are selected from the ranges quoted to total 100%.

A particularly preferred stabiliser composition comprises, calculated by weight of dry matter:

| | |
|---|---|
| cellulose gum | 10-20% |
| modified starch | 20-30% |
| maltodextrin | 20-30% |
| polydextrose | 10-20% |
| hydrocolloid | 3-10% |
| egg albumen | 3-18% |
| other ingredients | 0-15%. |

The preferred hydrocolloid is xanthan gum or a mixture of hydrocolloids containing xanthan gum.

An especially preferred stabiliser composition comprises, calculated by weight of dry matter:

| Ingredient | % |
|---|---|
| cellulose gum | 15.0 |
| modified starch | 24.0 |
| maltodextrin | 26.0 |
| polydextrose | 14.0 |
| xanthan gum | 6.0 |
| egg albumen | 15.0 |
| Total | 100.0 |

The stabiliser composition preferably is an aqueous fluid with a dry matter content of about 0.1% to about 10%, preferably 1% to about 8%, more preferably about 3% to about 5%.

Preferred cellulose gums may be selected from the group consisting of: methyl cellulose, hydroxypropyl methyl cellulose and carboxymethyl cellulose. Methyl cellulose or cellulose ethers particularly as sold under the trade mark METHOCEL A15 or A4M or a mixture thereof are especially preferred. Use of METHOCEL A15 is advantageous, having a lower viscosity than A4M, resulting in improved rates and efficiency of impregnation of the stabiliser into the substrate. An amount of about 10-20% by weight of dry matter, preferably about 15% by weight of matter may suitably be employed in the stabiliser composition.

Modified starches which may be employed comprise partially degraded starch which has been modified, for example by heating or acetylation. Hydroxyalkylated starch for example hydroxypropylated starch may be employed. A suitable modified starch is manufactured under the trade mark THERMFLO. An amount of about 20% to about 30% by weight of dry matter, preferably about 24% by weight of dry matter is preferred.

Suitable hydrocolloids for use in the gel composition may be selected from the group consisting of: xanthan gum, carageenan gum, guar gum and mixtures thereof. Use of xanthan gum, guar gum or mixtures thereof is particularly preferred Use of xanthan gum or a mixture of hydrocolloids containing xanthan gum is especially preferred. An amount of about 5% to 7% by weight of dry matter, particularly about 6% by weight of dry matter may be employed.

Further ingredients may be used as necessary. For example flavourings, preservatives or colourants may be added.

According to a second aspect of this invention a microwave or thermally cookable or reheatable food product comprises a substrate comprising pieces of poultry, fish, red meat, vegetable, dairy or processed foods;

the substrate being impregnated with a stabiliser composition comprising, calculated by weight of dry matter:

| | | |
|---|---|---|
| cellulose gum | 5-25 | wt. % |
| modified starch | 10-50 | wt. % |
| maltodextrin | 10-55 | wt. % |
| polydextrose | 0-45 | wt. % |
| protein | 0-20 | wt. % |
| hydrocolloid | 1-10 | wt. % |
| other ingredients | 0-30 | wt. % |

The food product may further comprise an aqueous coating applied to the impregnated substrate;

wherein the aqueous coating comprises water and 0.1 to 5% by dry weight of:

| | |
|---|---|
| cellulose gum | 15-35% |
| modified starch | 15-35% |
| hydrocolloid | 20-30% |
| proteinaceous component | 10-20%; |

a first coating of fine crumb applied to the aqueous coating to form a layer of fine crumb encasing the substrate;

an optional batter composition applied to the first coating to form a batter coating; and

an optional layer of outer crumb applied to the batter coating.

According to a further aspect of the present invention there is provided a method of manufacture of a thermally cookable or reheatable food product the method comprising the steps of:

providing a substrate comprising pieces of poultry, fish, red meat, vegetable, fruit and/or dairy food;

impregnating the substrate with a stabiliser composition as defined herein before to produce a stabilised substrate;

applying an aqueous coating composition onto the stabilised substrate to produce a coated substrate; and

applying a coating of fine crumb onto the coated substrate to form a crumbed product comprising a layer of fine crumb encasing the coated substrate.

In the present method the substrate can be impregnated with the stabiliser composition by applying the stabiliser composition onto the substrate, by immersing the substrate into the stabiliser composition or by injecting the stabiliser composition into the substrate. According to a particularly preferred embodiment, the stabiliser composition is applied by means of vacuum impregnation or injection.

According to a particularly preferred embodiment, the present method further comprises pre-frying of the crumbed substrate, optionally after application of further coating layers, and freezing of the pre-fried substrate.

The aqueous coating composition may be a viscous aqueous solution, may be thixotropic, or may be a gel which forms a solid or semi-solid consistency when not subjected to shear. The aqueous coating is preferably a free flowing viscous fluid or gel. It is referred in this specification as a “gel” or “aqueous coating” for convenience.

The aqueous coating composition preferably comprises water and about 0.1 wt. % to about 5 wt. % dry matter, said dry matter comprising:

| | |
|---|---|
| cellulose gum | 15-35% |
| modified starch | 15-50% |
| hydrocolloid | 20-30% |
| protein | 10-20% |

The preferred hydrocolloid in the aqueous coating composition is xanthan gum or a mixture of hydrocolloids containing xanthan gum.

The protein is preferably selected from the group consisting of: egg albumen, whey protein, soy protein and mixtures thereof. Use of egg albumen is preferred.

The aqueous coating composition preferably is a viscous solution or a gel with a dry matter content of about 0.1% to 5%, preferably about 0.3% to 3%, more preferably about 1%.

A particularly preferred aqueous coating composition comprises, calculated by weight of dry matter:

| | |
|---|---|
| cellulose gum | 20-30% |
| modified starch | 20-40% |
| hydrocolloid | 20-40% |
| egg albumen | 10-30% |

An especially preferred aqueous coating composition comprises, calculated by dry matter:

| Ingredient | % |
|---|---|
| cellulose gum | 25.0 |
| modified starch | 35.0 |
| xanthan gum | 25.0 |
| egg albumen | 15.0 |
| Total | 100.0 |

The aqueous coating composition exhibits good adhesion to the impregnated substrate. Adhesion of subsequently applied crumb or other fine particles is facilitated. The aqueous coating or gel coating also serves as an additional barrier to loss of moisture from the substrate during the subsequent microwave heating stage. Without wishing to be bound by theory it is believed that the gel coating composition adsorbs moisture escaping from the core and also serves as a barrier to fat pickup by the core, avoiding impairment of the flavour of the core. Impregnation of the core with an aqueous solution of the stabiliser contributes to the moisture content of the core during cooking or reheating.

In a first preferred embodiment of the invention a first coating of fine crumb is applied to the coated substrate.

Advantageously the fine crumb has a particle size of about 0.1 to about 1 mm, preferably about 0.25 mm to about 0.9 mm. Smaller particles for example crumb dust may be used. A 1 mm mesh sieve may be used to screen larger particles from the fines. The fine crumb may comprise fines resultant from milling during manufacture of crumb used for the exterior coating of a food product.

Untreated fines may be used, for example pin head rusk. However use of pin head rusk may not be preferred for certain applications due to a tendency to form a moist or slimy coating caused by picking up of water from contact with the aqueous coating or gel or from a batter composition applied to the fine crumb layer.

In advantageous embodiments of this invention crumb fines incorporating a hydrocolloid are employed. The hydrocolloid may be selected from guar gum, xanthan gum or mixtures thereof. Use of a hydrocolloid may provide a degree of water resistance to the fines reducing any tendency to pick up moisture from adjacent gel or batter layers. Use of fines resulting from the process for manufacture of crumb as disclosed in WO 2010/001101 is especially preferred. Gelatin or starches may not be employed as the hydrocolloid.

Application of a first coating of crumb fines may be difficult without use of an aqueous coating or gel applied as a pre-coat as disclosed above since the fines will not adhere sufficiently to a dry substrate, in contrast to a conventional pre-dust. Use of the aqueous coating or gel coating has the additional advantage that the fines layer may adhere to the substrate providing a complete covering or shell surrounding the stabilised substrate to reduce the escape of water vapour oringress of fat during frying. Application of the aqueous coating or gel allows formation of a complete coating on the substrate allowing adhesion of the first fine crumb to the entire surface forming an integral shell of the fine crumb.

The first crumb coating may be applied using a first crumb applicator, the crumb being applied in excess with the surplus shaken off.

A loading of the crumb layer may be about 5-10% of the weight of the stabilised substrate, dependent on the size of the substrate particles and other factors.

Following application of the first crumb, a coating of batter may be applied by immersion using a tempura applicator or other convenient apparatus. Following application of the batter layer a second outer crumb coating may be applied. Preferably two outer coatings of crumb are applied, the first coating being of larger particles followed by a further coating of smaller particles to fill any gaps between the larger particles.

In a second preferred embodiment a further coating of the aqueous coating composition is applied to the fine crumb instead of a batter layer. The outer crumb layer, when used may be applied to the batter coating or second aqueous coating to form a crumb coated food product.

In a preferred embodiment a first outer crumb coating comprises particles having a size of 1-3 mm preferably about 2 mm or larger as appropriate. The crumb may be applied in excess using a crumb applicator with surplus shaken off. The crumb coated substrate may be passed through a roller to improve adhesion.

A second outer coating of smaller particles of crumb for example having a size from about 0.2 to about 2 mm and preferably about 0.5 to about 1 mm may be applied dependent on the size of the substrate and the dimensions of the first outer crumb. Use of two crumb layers forms an integral coating without the batter layer being visible. A roller may be used to improve adhesion of the second crumb coating.

A method of stabilisation and stabiliser compositions in accordance with this invention may be used for coated products such as crumbed or pastry enrobed products. In addition the composition may be used for uncoated products including cooked meat, for example sausages and fish. Vegetables and fruit may also be stabilised.

The method may include the step of applying a first and optionally a second or further batter coating to the impregnated coated substrate.

A batter coating may be applied to the substrate. A suitable batter coating is disclosed in our Batter 3 EP 2356911 or WO 2012/175930, the disclosures of which are incorporated into the specification by reference for all purposes. Alternatively a coating as disclosed in WO96/32026 may be used.

A crumb coating may be applied to the batter coating. A preferred crumb coating is disclosed in WO 2010/001101, the disclosure of which is incorporated in to the present specification for all purposes by reference.

The battered and/or crumb coated product may be fried and then frozen for storage prior to use.

The coated product, whether frozen, chilled or fresh, may be reheated or cooked before use using a conventional oven or grill, by shallow or deep fry, or using an air fryer.

The pieces of the substrate may be whole portions, for example whole muscle portions such as individual steaks or fillets or larger pieces which may be cut into individual portions after cooking or reheating. Alternatively the pieces may comprise chopped or comminuted pieces, for example, nuggets or minced products which may be reformulated into larger portions.

The invention is further described by means of example but not in any limitative sense.

### EXAMPLE 1

### Stabiliser Composition

A stabiliser composition was prepared using the following ingredients:—

| Ingredient | % |
|---|---|
| cellulose gum (Methocel A4M) | 15.0 |
| modified starch (Thermflo) | 24.0 |
| maltodextrin | 40.0 |
| xanthan gum | 6.0 |
| egg albumen | 15.0 |
| Total | 100.0 |

### EXAMPLE 2

### General-Purpose Stabiliser Composition

A composition of the following ingredients was used to form a viscous fluid coating composition

| Ingredient | % |
|---|---|
| Methylcellulose (Methocel A4M) | 15.0 |
| modifiedstarch (Thermflo) | 24.0 |
| egg albumen | 15.0 |
| xanthan gum | 6.0 |
| maltodextrin | 40.0 |
| Total | 100.0 |

In these examples the methylcellulose may be replaced by the same amount of Methocel A15.

The composition was dissolved in water to produce a solution with a concentration suitable to stabilise the particular substrate in use. This general purpose formula may be modified to increase its efficiency in specific substrates. The above formula may be modified by addition of citric acid (up to 1%) and ascorbic acid (up to 2%) with the dextrose (component II) being reduced accordingly.

### EXAMPLE 3

### Preparation of Stabiliser Composition

The dry powder mixture was partially hydrated in a tub and then poured into a bowl chopper. The bowl chopper was then run for two to three minutes until fully hydrated. The mixture can be hydrated directly in the bowl chopper if required. Alternatively, the stabiliser may be hydrated using a high shear mixer fitted with a general purpose head.

### EXAMPLE 4

### Impregnation of the Substrate with the Stabiliser Composition

A chicken mixture for chicken dippers or nuggets was prepared with the following composition which was prepared as a dry mixture, as an alternative to use of a hydrated stabiliser composition. The stabiliser of Example 1 was used.

| Ingredient | % |
|---|---|
| chicken emulsion | 20.0 |
| skin - 3 mm | 18.0 |
| chicken breast - 10 mm | 50.0 |
| water | 2.0 |
| rusk | 2.0 |
| stabiliser (Example 1) | 5.0 |
| seasoning | 3.0 |
| Total | 100.0 |

The chicken breast was chilled to −3° C. and minced using a 10 mm plate. After mincing, the temperature was 0-3° C. Water was added with mixing. A chicken emulsion comprising the following ingredients was added with mixing:

| Ingredient | % |
|---|---|
| chicken skin | 44.0 |
| water | 44.0 |
| soya isolate | 11.0 |
| salt | 1.0 |
| Total | 100.0 |

The stabiliser in accordance to Example 1 was added and mixed thoroughly. Rusk was added with mixing following by seasoning. A dry powder flavouring was preferred. The composition was allowed to dissolve in use in water which was present in the substrate in order to form an aqueous stabiliser solution in situ.

A vacuum was applied to the mixture to consolidate the structure following which the chicken mixture was chilled to −3° C. and formed into shaped pieces.

A similar procedure was used for other comminuted meat products. Large particulate cores may be manufactured using a similar method.

### EXAMPLE 5

### Impregnation of a Chicken Mixture with the Stabiliser Composition

| Ingredient | % |
|---|---|
| chicken breast meat (13 mm) | 79.0 |
| salt | 1.0 |
| water | 12.0 |
| stabiliser(Example 1) | 5.0 |
| inuline and seasoning | 3.0 |
| Total | 100.0 |

### EXAMPLE 6

### Impregnation of a Fish Mixture with a Stabiliser Composition

| Ingredient | % |
|---|---|
| cod fillet blocks (partially thawed) | 85.8 |
| salt | 0.9 |
| water | 4.6 |
| stabiliser(Example 1) | 4.8 |
| fish binder | 3.9 |
| Total | 100 |

### EXAMPLE 7

### Batter Coating Composition

A batter coating composition was prepared by mixing the following ingredients:

| Ingredient | % |
|---|---|
| soya flour (Full Fat) | 62.0 |
| maize flour | 26.5 |
| soya flour | 9.6 |
| guar gum | 0.5 |
| milk protein | 0.5 |
| sodium bicarbonate | 0.4 |
| Sodium carboxymethylcellulose | 0.3 |
| xanthan | 0.2 |
| Total | 100.0 |

The batter can be mixed in batches using a Silverson DX high shear mixer on a gantry with a slotted disintegrating head. Batches were mixed in the ratio of 25 kilos water to 12.5 kilos dry batter powder in a vat with a diameter of 68 cm. Thereafter, the mix was diluted as required for example to give a ratio of water:powder of 2.4:1.

In full scale production the batter ingredients were mixed in a ratio of water:powder of 2.4:1 using two 200 litre stainless steel vessels linked by a pump and an inline Silverson mixer with a high shear slotted disintegrating head. One tank was fitted with a paddle and was filled with water at 15-20° C. The dry ingredients were added to the water and wetted by rotation of the paddle. The second tank was fitted with a cooling jacket and a return pipe to the first vessel. The batter mixture was circulated through the high shear head until a temperature of 42° C. was reached by mechanical heat transfer. The start temperature of the water may be increased to reduce mixing time. When 42° C. was reached, the mixing and enzymolysis were complete. The batter was transferred to the second vessel and cooled. A heat exchanger may be used to cool the mixture. After cooling, the batter was pumped into a tempura-type batter applicator.

The viscosity in the batter mixture was in the range 550-650 cP as measured by a number 3 spindle at 60 rpm. The batter was found to give a good rate of pickup and a crisp coating after frying.

### EXAMPLE 8

### Aqueous Coating Composition

The following mixture was prepared:

| Ingredient | % |
|---|---|
| modified starch (Thermflo) | 35.0% |
| thickener (MethocelA4M) | 25.0 |
| xanthan gum | 25.0 |
| egg albumen | 15.0 |
| Total | 100.0 |

The mixture was dissolved in water to form a 1% solution using a CFS Scanbrine mixer with paddle agitation. The solution was left to stand for 24 hours to form a fully hydrated gel or viscous aqueous solution

The aqueous coating was applied to impregnated substrates of Examples 4 to 7 using a tempura-type batter applicator in which the substrate particles were dipped.

A pump is necessary to run the machine but after a short while bubbles form in the solution or gel in the applicator. To prevent this problem, food grade anti-foaming agents can be used. Polydimethylsiloxane is preferred but calcium alginate, methyl ethyl cellulose, methylphenylpolysiloxane or polyethylene glycol can be used.

### EXAMPLE 9

### Crumb Application

A crumb was prepared as disclosed in WO 2010/001101, the disclosure of which is incorporated herein by reference for all purposes.

Following application of the aqueous coating as described in Example 8, a fine crumb was applied with a mesh size less than 1 mm or such as may be described as a dust, using a CFS Crumbmaster breadcrumb applicator.

The fine crumb coated impregnated substrate was passed through the batter of Example 7 in a tempura batter applicator.

A 2 mm crumb was applied in a second CFS Crumbmaster breadcrumb applicator with slight pressure from a roller. Particles were passed through a third CFS Crumbmaster breadcrumb applicator to infill with a 1 mm crumb using light pressure from a roller.

### EXAMPLE 10

### Frying and Cooking

The coated substrate of Example 9 was fried in pure, fresh rapeseed oil for 2 minutes approximately at 180-188° C. The frying time can be varied depending upon the weight and size of the particles. After frying, the core temperature was 74-85° C. A small loss of weight was observed due to loss of water from the substrate but this is mostly compensated for by the uptake of oil.

1. A stabiliser composition comprising, calculated by weight of dry matter:

| | | |
|---|---|---|
| cellulose gum | 5-25 | wt. % |
| modified starch | 10-50 | wt. % |
| maltodextrin | 10-55 | wt. % |
| polydextrose | 0-45 | wt. % |
| protein | 0-20 | wt. % |
| hydrocolloid | 1-10 | wt. % |
| other ingredients | 0-30 | wt. %. |

2. A stabiliser composition as claimed in claim 1, wherein the cellulose gum is selected from the group consisting of methyl cellulose, hydroxypropyl methyl cellulose, carboxymethyl cellulose and combinations thereof.

3. A stabiliser composition as claimed in claim 1, wherein the modified starch is hydroxyalkylated starch.

4. A stabiliser composition as claimed in claim 1, wherein the maltodextrin has a dextrose equivalent (DE) in the range of 3 to 20.

5. A stabiliser composition as in claim 1, wherein the protein is selected from the group consisting of egg albumen, whey protein, soy protein and combinations thereof.

6. A stabiliser composition as claimed in claim 4 wherein the proteinaceous component is egg albumen.

7. A stabiliser composition as claimed in claim 1, wherein the hydrocolloid is selected from the group consisting of xanthan gum, carageenan gum, guar gum and mixtures thereof.

8. A stabiliser composition as claimed in claim 7, wherein the hydrocolloid is selected from the group consisting of xanthan gum, guar gum and mixtures thereof.

9. A stabiliser composition as claimed in claim 8, wherein the hydrocolloid comprises xanthan gum or a mixture of hydrocolloids including xanthan gum.

10. A stabiliser composition as claimed in claim 1, wherein the stabiliser composition comprises 20-55 wt. % maltodextrin, calculated by weight of dry matter.

11. A stabiliser composition as claimed in claim 1, wherein the stabiliser composition is an aqueous fluid having a dry matter content of 0.1-10 wt. %.

12. A method of manufacture of a microwave or thermally cookable or reheatable food product; the method comprising the steps of:
providing a substrate comprising pieces of poultry, fish, red meat, vegetable, fruit and/or dairy food;
impregnating the substrate with a stabiliser composition as claimed in any one of the preceding claims to produce a stabilised substrate;
applying an aqueous coating composition onto the stabilised substrate to produce a coated substrate; and
applying a coating of fine crumb onto the coated substrate to form a crumbed substrate comprising a layer of fine crumb encasing the coated substrate.

13. A method of manufacture of a food product as claimed in claim 12, wherein the substrate is impregnated with the stabiliser composition by applying the stabiliser composition onto the substrate, by immersing the substrate into the stabiliser composition or by injecting the stabiliser composition into the substrate.

14. A method of manufacture of a food product as claimed in claim 12, wherein the method further comprises the steps of pre-frying of the crumbed substrate, optionally after application of one or more further coating layers, and freezing of the pre-fried substrate.

15. A frozen microwave or thermally cookable or reheatable food product obtained by the method as claimed in claim 14.
